(19) United States
(12) Patent Application Publication
(10) Pub. No.: US 2011/0110681 A1
(43) Pub. Date: May 12, 2011

(54) Method of Making an Electronic Circuit for an Imaging Machine

(76) Inventors: Steven Miller, Pinellas Park, FL (US); Herman Schnell, Coral Springs, FL (US)

(21) Appl. No.: 13/008,777

(22) Filed: Jan. 18, 2011

Related U.S. Application Data
(63) Continuation-in-part of application No. 12/793,471, filed on Jun. 3, 2010.
Application No. 12/793,471 is a continuation of application No. 12/616,624, filed on Nov. 11, 2009, now abandoned.
Application No. 12/616,624 is a continuation of application No. 12/122,098, filed on May 16, 2008, now Pat. No. 7,643,773.
Application No. 12/122,098 is a continuation of application No. 12/013,387, filed on Jan. 11, 2008, now Pat. No. 7,512,360.
Application No. 12/013,387 is a continuation of application No. 11/382,589, filed on May 10, 2006, now Pat. No. 7,362,988.
Application No. 11/382,589 is a division of application No. 10/742,323, filed on Dec. 19, 2003, now Pat. No. 7,136,608.

(51) Int. Cl. G03G 15/00

(52) U.S. Cl. 399/109

(57) ABSTRACT

A method of making an electronic circuit for activating an imaging machine includes providing a first electronic circuit that is not capable of authenticating itself to the imaging machine; providing a second electronic circuit comprising an electronic component that is capable of authenticating itself to the imaging machine; removing the electronic component from the second electronic circuit; and electrically connecting the electronic component to the first electronic circuit, such that the first electronic circuit can use the electronic component to authenticate the first electronic circuit to the imaging machine.

### CROSS REFERENCE TO RELATED APPLICATIONS

This application is a continuation-in-part of co-pending U.S. patent application Ser. No. 12/793,471, filed Jun. 3, 2010, entitled “Enhanced Imaging Cartridge,” which is a continuation of U.S. patent application Ser. No. 12/616,624, filed Nov. 11, 2009, entitled “Universal Imaging Cartridge Chip,” which is a continuation of U.S. patent application Ser. No. 12/122,098, filed May 16, 2008, entitled “User-Friendly Imaging Cartridge,” which is a continuation of U.S. patent application Ser. No. 12/013,387, filed Jan. 11, 2008, now U.S. Pat. No. 7,512,360, entitled “Imaging Cartridge Having a Universal Body,” which is a continuation of U.S. patent application Ser. No. 11/382,589, filed May 10, 2006, now U.S. Pat. No. 7,362,988, entitled “Universal Toner Cartridge Mounts for Attaching a Waste Bin to a Hopper,” which is a divisional application of U.S. patent application Ser. No. 10/742,323, filed Dec. 19, 2003, now U.S. Pat. No. 7,136,608, entitled “Removable Toner Cartridge Universal Adapter.”

### BACKGROUND OF THE INVENTION

The present invention relates to an imaging cartridge adapted to fit within an imaging cartridge-receiving cavity of an imaging machine.

Laser imaging machines use a coherent beam of light, hence the term “laser imaging machine,” to expose discrete portions of an image transfer drum thus attracting the printing toner. Toner is a mixture of pigment (most commonly black) and plastic particles. The toner becomes electro-statically attracted to exposed portions of the photoconductive transfer drum.

The photoconductive drum rotates opposite the developer roller, the developer roller being in fluid contact with the toner. The toner is transferred to paper, or other medium, as it passes over the rotating image transfer drum. Subsequently, the paper is heated so that the plastic is melted thereby permanently affixing the ink to the paper.

Most Original Equipment Manufacturers (OEM's) design their imaging machines to accept imaging cartridges manufactured by it and to reject the imaging cartridges manufactured by others. More particularly, to increase sales of their own imaging cartridges, imaging machine manufacturers have added electronic identification features to the imaging machines and to the imaging cartridges that do not enhance the functional performance of the imaging machine in any way but which serve to prevent use of a competitor's imaging cartridge in the imaging machine. Imaging machine manufacturers also prefer to sell new imaging cartridges to replace empty imaging cartridges. Therefore, they do not support the re-cycling industry.

Specifically, OEM's have attempted to prevent re-cycling of imaging cartridges by installing single-use electronic circuits on the cartridges required to activate the imaging machine, allowing interoperation of the imaging machine and the imaging cartridge. During operation, the imaging machine queries the imaging cartridge's electronic circuit and the circuit must respond to the query with the correct information to authenticate itself. Once authenticated, the OEM electronic circuit continues to communicate with the imaging machine, sending information such as ink level, type of ink, color of ink, in addition to other information. Once the toner level of the cartridge becomes empty, the imaging machine writes information to the electronic circuit labeling the circuit as having reached its end of life.

However, even though the circuit has been written to as reaching its end of life, the circuit is still able to respond to the imaging machine's query to authenticate itself, but once the imaging machine has authenticated the electronic circuit, the imaging machine will see that the circuit has been written to as having reached its end of life and the imaging machine will cease to operate with the imaging cartridge.

Once an imaging cartridge has reached the end of its life and the OEM electronic circuit has been written to by the imaging machine, the imaging cartridge can be re-cycled by replacing the end of life OEM electronic circuit with a new aftermarket electronic circuit. Aftermarket electronic circuits typically comprise circuitry that performs the function of emulating the OEM electronic circuitry, so that the imaging machine is able to communicate with the aftermarket electronic circuit as it would with an OEM circuit. To emulate the OEM electronic circuit, the aftermarket circuit must be able to respond to the imaging machine's queries with the correct information in order to authenticate itself. However, OEM's keep this required information secret.

In some instances, manufacturers of aftermarket electronic circuits are able to determine the correct information to send to the imaging machine to answer the query, but in other instances the correct information cannot be determined and therefore the aftermarket circuit cannot authenticate itself. In these cases, another method must be used to authenticate the aftermarket electronic circuit to the imaging machine.

Thus there is a need for a method of making an electronic circuit that can authenticate itself to an imaging machine when the correct authentication information is not known.

### SUMMARY OF THE INVENTION

The long-standing but heretofore unfulfilled need for a method of creating an electronic circuit that can authenticate itself to an imaging machine when the correct authentication information is not known is now met by a new, useful, and non-obvious invention.

The OEM electronic circuit uses a component such as an EEPROM or microprocessor to authenticate itself to the imaging machine. This authenticating component that the OEM circuit uses is specifically designed to authenticate a certain model of imaging machine. Even without knowing the correct authentication information to send the imaging machine, an aftermarket electronic circuit can authenticate itself by using the specific component that the OEM electronic circuit uses. However, the components that OEM electronic circuits use to perform the task of authenticating the circuit to the imaging machine are proprietary, and these proprietary components are only available to the OEM. Therefore, aftermarket electronic circuit manufacturers are not able to obtain on the open market, the same authenticating components that the OEM can obtain.

One method of solving this problem and achieving the present invention is to remove the component that is responsible for authentication of the OEM electronic circuit from the OEM circuit and electrically connect the component to an aftermarket electronic circuit. In this embodiment, the aftermarket circuit will use the component from the OEM circuit to authenticate itself to the imaging machine, and then the function of sending the other communications to the imaging machine will be performed by the other components on the aftermarket electronic circuit.

Therefore, one embodiment of the present invention is directed at a method of making an electronic circuit for activating an imaging machine comprising the steps of: providing a first electronic circuit that is not capable of authenticating itself to the imaging machine; providing a second electronic circuit comprising an electronic component that is capable of authenticating itself to the imaging machine; removing the electronic component from the second electronic circuit; and electrically connecting the electronic component to the first electronic circuit. In a further embodiment, the first electronic circuit receives an authentication query from the imaging machine; the first electronic circuit directs the authentication query to the electronic component; and the electronic component authenticates the first electronic circuit to the imaging machine.

In a second embodiment of the invention, instead of redirecting the imaging machine's authentication sequence to the OEM authenticating component, the aftermarket electronic circuit acts as a master device to the OEM electronic circuit and emulates the imaging machine communications to the OEM electronic circuit. It is known in the industry that a master device initiates communications with a slave device, which responds to those communications. A slave device never initiates communications with the master. Acting as a master device to the OEM circuit allows the aftermarket circuit to extract key information from the OEM circuit such as serial numbers, toner yield equations, toner load, color correction coefficients, printing process parameters, etc. In this embodiment, the aftermarket electronic circuit accesses the aftermarket electronic circuit by exploiting weaknesses in the authentication or encryption security of the OEM electronic circuit. These weaknesses are not normally detected since the imaging machine never issues commands to reveal them, but once detected they can be used to access the OEM electronic circuit.

As an example, some OEM electronic circuits have special modes of operation that are only used during the manufacturing process to configure the OEM circuit. Sometimes these special modes are used to load firmware into the OEM electronic circuit, but other times they are used to load the cartridge parameters into the OEM circuit once the OEM circuit is attached to the imaging cartridge. By accessing the OEM electronic circuit while it is in one of these special modes, the aftermarket electronic circuit is able to act like the imaging machine and extract the key information needed for interoperability with the imaging machine. These special modes can be accessed by the aftermarket electronic circuit by exploiting weaknesses in the authentication or encryption security of the OEM electronic circuit.

Therefore, another embodiment of the present invention is directed at a method of activating an imaging machine, said method comprising the steps of: providing a first electronic circuit missing at least one required piece of information to activate said imaging machine; providing a second electronic circuit comprising an electronic component, said electronic component comprising said required piece of information to activate said imaging machine; said first electronic circuit accessing said electronic component while said electronic component is in a special mode not used during activation of said imaging machine; said first electronic circuit receiving said required piece of information from said electronic component; and said first electronic circuit sending said required piece of information to said imaging machine to activate said imaging machine.

In another example, the aftermarket electronic circuit becomes the master to the OEM electronic circuit and emulates the imaging machine to the OEM circuit. Normally only the imaging machine is the master to the OEM electronic circuit, but once the aftermarket circuit becomes master to the OEM circuit, the aftermarket circuit is able to mimic the imaging machine by sending commands to the OEM electronic circuit that the imaging machine normally would, in order to get the responses back from the OEM electronic circuit that are needed to emulate the OEM electronic circuit to the imaging machine. So when the imaging machine initiates communication with the aftermarket electronic circuit and requests specific information, the aftermarket electronic circuit sends a communication to the OEM electronic circuit to get the key information that it needs to respond to the imaging machine.

In some instances, it may be necessary for the aftermarket electronic circuit to communicate at a higher speed to the OEM electronic circuit, since there is a limited amount of time allowed by the imaging machine to receive a response from the electronic circuit before the imaging machine times out. In order to facilitate a quicker response to the imaging machine, the aftermarket electronic circuit may communicate to the OEM electronic circuit during idle times when the imaging machine is not communicating with the cartridge and store the results received from the OEM circuit in the memory of the aftermarket electronic circuit. This way, when the imaging machine needs a response, the aftermarket electronic circuit already has the information available and a response can be sent to the imaging machine immediately.

Therefore, another embodiment of the present invention is directed at a method of activating an imaging machine, said method comprising the steps of: providing a first electronic circuit missing at least one required piece of information to activate said imaging machine; providing a second electronic circuit comprising an electronic component, said electronic component comprising said required piece of information to activate said imaging machine; said first electronic circuit sending a request to said electronic component for said required piece of information, said request from said first electronic circuit emulating a request normally sent by the imaging machine; said electronic component sending said required piece of information to said first electronic circuit; said first electronic circuit receiving said required piece of information from said electronic component; and said first electronic circuit sending said required piece of information to said imaging machine to activate said imaging machine.

In another embodiment, the aftermarket electronic circuit uses a component of the OEM electronic circuit as an extra memory storage device to increase the memory available to store imaging machine parameters. Using the additional memory in the OEM electronic circuit allows the aftermarket electronic circuit to have a lower cost since the size of the memory affects the cost of the electronic circuit. This embodiment allows the aftermarket electronic circuit to initially have very little memory and then use the OEM electronic circuit as the main storage for data, while the aftermarket electronic circuit only has to store the data related to the toner levels or page counts. So in this way the OEM electronic circuit is used for a new purpose in addition to providing authentication.

In this embodiment, the aftermarket electronic circuit can create a new memory map in the OEM electronic circuit. This embodiment provides a cost advantage since the end-of-life OEM electronic circuits have little value and are often discarded as waste.

Therefore, yet another embodiment of the present invention is directed at a method of activating an imaging machine, said method comprising the steps of: providing a first electronic circuit adapted to activate said imaging machine; providing a second electronic circuit comprising a memory device; electrically connecting said first electronic circuit to said memory device; sending information from said first electronic circuit to said memory device; and storing said information on said memory device.

### BRIEF DESCRIPTION OF THE DRAWINGS

FIG. 1 is a perspective view of an OEM electronic circuit.

FIG. 2 is a perspective view of an aftermarket electronic circuit incorporating a component from an OEM electronic circuit.

FIG. 3 is a flow chart of the aftermarket circuit mimicking an imaging machine.

### DETAILED DESCRIPTION OF THE PREFERRED EMBODIMENT

Certain models of imaging cartridges comprise an electronic circuit that performs various functions. These functions include storing information unique to the specific imaging cartridge such as ink level, type of ink, color of ink, in addition to other information. Throughout operation of the cartridge in the imaging machine, the electronic circuit communicates this information to the imaging machine in order to let the imaging machine know the specific details of the cartridge. The imaging machine then uses the information to set certain parameters for operation.

Another function of the OEM electronic circuit is to prevent re-cycling of the imaging cartridge by third parties. For example, when the toner level of the imaging cartridge reaches an empty state, the imaging machine disables the electronic circuit by writing data to the circuit indicating that the circuit's life is over. Once this end-of-life data has been written to the circuit, the imaging machine will not operate with the circuit any longer. As a result, the imaging cartridge cannot be re-filled and re-used because the imaging machine will recognize the electronic circuit as having reached the end of its life and therefore the circuit will not be able to activate the imaging machine.

Once the OEM circuit has reached it end of life, the only way to re-cycle the imaging cartridge is to use an aftermarket electronic circuit to replace the OEM circuit. However, the communications between the imaging machine and the imaging cartridge's electronic circuit are very complex and encrypted using algorithms such as Elliptic Curve Cryptography (ECC), Advanced Encryption Standard (AES), and Data Encryption Standard (DES). Therefore, complete emulation of an OEM electronic circuit is extremely difficult.

In some instances, as with the Lexmark T650 engine of imaging machines, the OEM electronic circuit contains a proprietary bi-directional data processor, such as an EEPROM or microprocessor, that is able to receive and send information. The OEM bi-directional data processor contains the correct information needed to communicate to the imaging machine in order to authenticate the circuit to the imaging machine to activate the imaging machine. However, the very nature of a proprietary component is that it can only be obtained by the OEM, and therefore the only way for the proprietary component to be used in an aftermarket electronic circuit is to remove the proprietary component from the OEM electronic circuit and insert it into the aftermarket circuit.

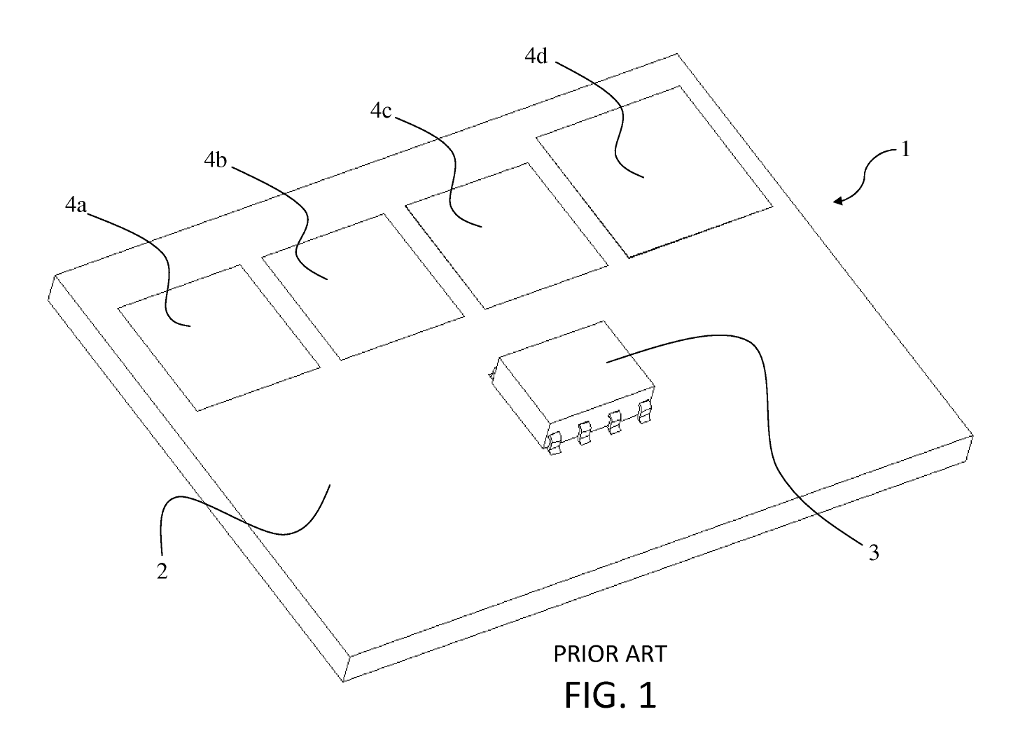

FIGS. 1 illustrates an OEM electronic circuit, wherein OEM electronic circuit 1 comprises circuit board 2, proprietary EEPROM 3, contact pads 4a, 4b, 4c, and 4d, and other electronic components (not shown). Proprietary EEPROM 3 is mounted on circuit board 2 and is electrically connected to contact pads 4a, 4b, 4c, and 4d. Once the imaging cartridge is installed in the imaging machine, electrical contact pads 4a, 4b, 4c, and 4d of electronic circuit 1 mate with electrical contacts located in the imaging machine enabling communications to be sent between the imaging machine and the electronic circuit. During normal operation, the imaging machine sends a query to electronic circuit 1 requiring electronic circuit 1 to authenticate itself. Electronic circuit 1 uses EEPROM 3 to send the correct information to the imaging machine thus authenticating electronic circuit 1. In this communication sequence, the imaging machine is the master and the electronic circuit is the slave because the electronic circuit is designed to respond to commands from the imaging machine and never initiate communication with the imaging machine.

Once the imaging cartridge has been depleted of toner, the imaging machine writes a command to EEPROM 3 labeling EEPROM 3 as having reached its end of life. At this point, EEPROM 3 is still capable of authenticating itself to the imaging machine, but after authentication the imaging machine recognizes that the life of the electronic circuit has expired and the imaging machine will cease to operate with the imaging cartridge.

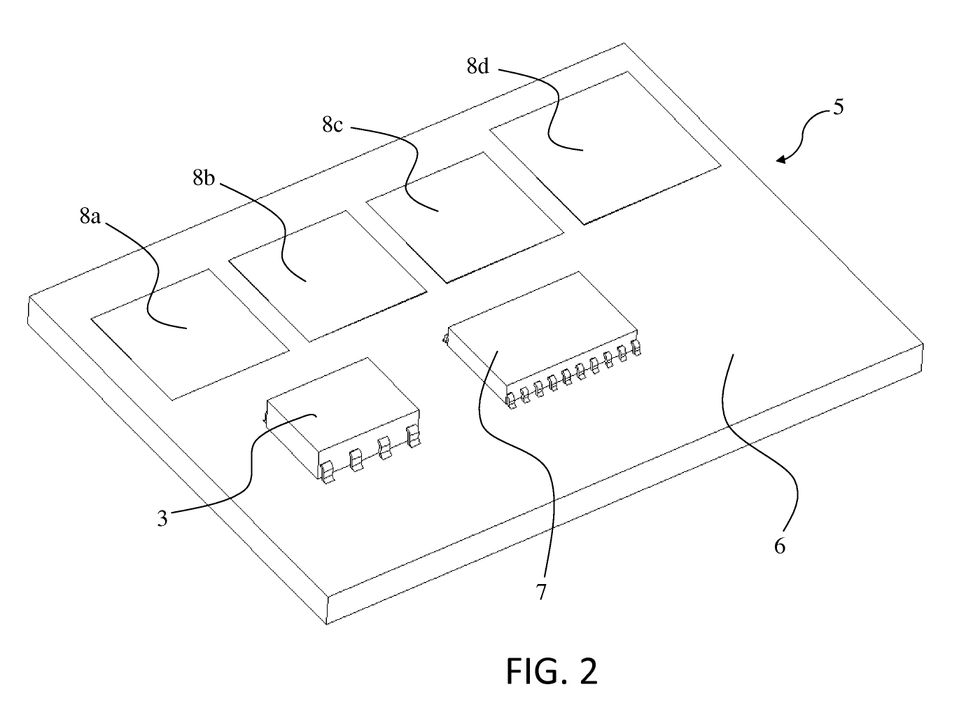

FIG. 2 illustrates the preferred embodiment of the present invention, wherein EEPROM 3, which has been written to as reaching its end of life, is removed from OEM electronic circuit 1 and electrically connected to aftermarket electronic circuit 5. Aftermarket electronic circuit 5 comprises circuit board 6, microprocessor 7, electrical contact pads 8a, 8b, 8c, and 8d, and EEPROM 3 that has been removed from OEM electronic circuit 1. Once installed in the imaging machine, electrical contact pads 8a, 8b, 8c, and 8d of electronic circuit 5 mate with electrical contacts located in the imaging machine enabling communications to be sent between the imaging machine and the electronic circuit. Microprocessor 7 is responsible for receiving communications from the imaging machine and determining which responses are sent back to the imaging machine. When the imaging machine sends a query to electronic circuit 5 requiring electronic circuit 5 to authenticate itself to the imaging machine, microprocessor 7 directs the imaging machine's query to EEPROM 3 so that EEPROM 3 will authenticate aftermarket electronic circuit 5 to the imaging machine. Once authenticated, the aftermarket electronic circuit communicates with the imaging machine, sending to the imaging machine information unique to the imaging cartridge such as ink level, type of ink, color of ink, in addition to other information. Periodically, throughout the life of aftermarket electronic circuit 5, the imaging machine will query electronic circuit 5 to authenticate itself. In each of these instances, microprocessor 7 will direct the query to EEPROM 3 in order to achieve authentication.

In another embodiment, the aftermarket electronic circuit uses the OEM bi-directional data processor as an extra memory storage device to increase the memory available to store information. By using the additional memory in the OEM bi-directional data processor, it allows the aftermarket electronic circuit to have a lower cost since the size of the memory affects the cost of the electronic circuit. This embodiment allows the aftermarket electronic circuit to initially have very little memory and then use the OEM bi-directional data processor as the main storage for data, while the aftermarket electronic circuit only has to store the data related to the toner levels or page counts. In this embodiment, the aftermarket electronic circuit can create a new memory map in the OEM bi-directional data processor.

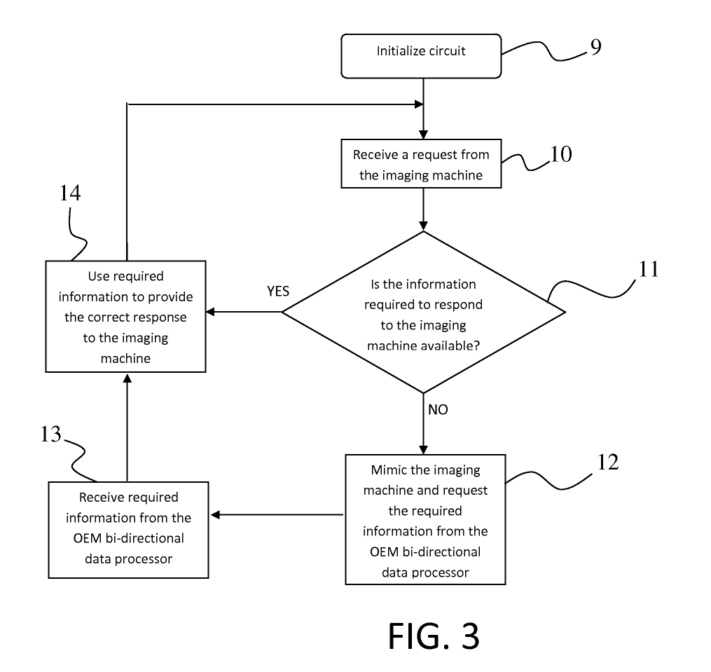

FIG. 3 is a flow chart illustrating another embodiment of the invention where the aftermarket electronic circuit receives the information required to respond to the imaging machine from the OEM bi-directional data processor, so the aftermarket circuit can respond to the imaging machine directly instead of relying on the end-of-life OEM bi-directional data processor to send the required information to the imaging machine. In this embodiment, the aftermarket electronic circuit becomes a master to the OEM bi-directional data processor and mimics the imaging machine by sending the same communications to the OEM electronic circuit that the imaging machine typically would. Because the aftermarket electronic circuit sends the same communications to the OEM bi-directional data processor that the imaging machine normally would, the OEM bi-directional data processor responds to the aftermarket circuit with the same communications that it would provide to the imaging machine. The aftermarket circuit can then use the communications received from the OEM bi-directional data processor to respond to the imaging machine, and thus activate the imaging machine.

Upon start up, the aftermarket electronic circuit initializes itself 9 and prepares to receive communications from the imaging machine. Once a request from the imaging machine is received 10, it is determined whether the information required to respond to the imaging machine is available 11. If the information is available, the information is used to provide the correct response to the imaging machine 14. If the information is not available, the aftermarket circuit sends a communication to the OEM bi-directional data processor that mimics a communication that would normally be sent by the imaging machine 12. The OEM bi-directional data processor responds to the communication with the correct information needed to send to the imaging machine, and this correct information is received 13 and used to provide the correct response to the imaging machine 14.

When the imaging machine sends a request to the electronic circuit, it requires the electronic circuit to respond in a very short amount of time or else the imaging machine will reject the electronic circuit. Therefore, it is beneficial to the aftermarket electronic circuit to start obtaining information from the OEM bi-directional data processor before the imaging machine requests the information. In this embodiment, the aftermarket electronic circuit communicates to the OEM bi-directional data processor during idle times when the imaging machine is not communicating with the cartridge and stores the results in the memory of the aftermarket electronic circuit. This way, when the imaging machine requests a response, the aftermarket electronic circuit already has the information available and a response can be sent to the imaging machine immediately.

In yet another embodiment, the aftermarket electronic circuit obtains information from the OEM bi-directional data processor by accessing the processor through a special mode of operation of the processor. This special mode is different from the mode the OEM electronic circuit uses to respond to imaging machine requests; it is used to load information into the OEM bi-directional data processor such as firmware or cartridge parameters once the OEM electronic circuit is attached to the imaging cartridge.

The special mode is accessed by exploiting weaknesses in the authentication or encryption security of the OEM electronic circuit. These weaknesses are not normally detected since the imaging machine never issues commands to reveal them, but once detected they can be used to access the OEM electronic circuit. By accessing the OEM electronic circuit through this special mode, the aftermarket electronic circuit simply sends a read command to the OEM bi-directional data processor to read the information stored on the processor such as the serial number, toner yield equations, toner load, color correction coefficients, printing process parameters, etc. Once obtained, this information is used to respond to the imaging machine's queries.

In the above embodiments, the aftermarket electronic circuit acts as a master to the OEM bi-directional data processor, but it is also possible for the aftermarket circuit to act as a master to the OEM electronic circuit to achieve the same result. Additionally, although the preferred embodiment describes an OEM electronic circuit that uses a bi-directional data processor such as a microprocessor or EEPROM to send authentication information to the imaging machine, it should be understood that any component that can authenticate an electronic circuit to an imaging machine falls within the scope of the invention. Furthermore, the preferred embodiment discusses using a component from an OEM electronic circuit to authenticate the aftermarket electronic circuit, however any component, OEM or not, that can authenticate an electronic circuit to the imaging machine can be used.

Additionally, the preferred embodiment teaches an aftermarket electronic circuit that uses a microprocessor, however any bi-directional data processor such as an EEPROM can replace the microprocessor to accomplish the invention.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

What is claimed is:

1. A method of making an electronic circuit for activating an imaging machine, said method comprising the steps of:
providing a first electronic circuit that is not capable of authenticating itself to the imaging machine;
providing a second electronic circuit comprising an electronic component that is capable of authenticating itself to the imaging machine;
removing said electronic component from said second electronic circuit; and
electrically connecting said electronic component to said first electronic circuit.

2. The method of claim 1, wherein:
said electronic component is a bi-directional data processor.

3. The method of claim 2, wherein:
said bi-directional data processor is a microprocessor or an EEPROM.

4. The method of claim 1, wherein:
said electronic component has been used to activate an imaging machine prior to being removed from said second electronic circuit.

5. The method of claim 4, wherein:
said imaging machine is a first imaging machine; and
said electronic component has been written to by said first imaging machine or a second imaging machine as having reached its end of life prior to being removed from said second electronic circuit.

6. The method of claim 1, further comprising the steps of:
said first electronic circuit receiving an authentication query from said imaging machine;
said first electronic circuit directing said authentication query to said electronic component; and
said electronic component authenticating said first electronic circuit to said imaging machine.

7. A method of activating an imaging machine, said method comprising the steps of:
providing a first electronic circuit missing at least one required piece of information to activate said imaging machine;
providing a second electronic circuit comprising an electronic component, said electronic component comprising said required piece of information to activate said imaging machine;
said first electronic circuit sending a request to said electronic component for said required piece of information, said request from said first electronic circuit emulating a request normally sent by the imaging machine;
said electronic component sending said required piece of information to said first electronic circuit;
said first electronic circuit receiving said required piece of information from said electronic component; and
said first electronic circuit sending said required piece of information to said imaging machine to activate said imaging machine.

8. The method of claim 7, further comprising the step of:
removing said electronic component from said second electronic circuit.

9. The method of claim 8, wherein:
said first electronic circuit comprises a circuit board.

10. The method of claim 9, further comprising the step of;
mounting said electronic component onto said circuit board.

11. A method of activating an imaging machine, said method comprising the steps of:
providing a first electronic circuit adapted to activate said imaging machine;
providing a second electronic circuit comprising a memory device;
electrically connecting said first electronic circuit to said memory device;
sending information from said first electronic circuit to said memory device; and
storing said information on said memory device.

12. The method of claim 11, further comprising the step of:
removing said memory device from said second electronic circuit.

13. The method of claim 12, wherein:
said first electronic circuit comprises a circuit board.

14. The method of claim 13, further comprising the step of;
mounting said memory device onto said circuit board.

15. A method of activating an imaging machine, said method comprising the steps of:
providing a first electronic circuit missing at least one required piece of information to activate said imaging machine;
providing a second electronic circuit comprising an electronic component, said electronic component comprising said required piece of information to activate said imaging machine;
said first electronic circuit accessing said electronic component while said electronic component is in a special mode not used during activation of said imaging machine;
said first electronic circuit receiving said required piece of information from said electronic component; and
said first electronic circuit sending said required piece of information to said imaging machine to activate said imaging machine.

16. The method of claim 15, further comprising the step of:
once said first electronic circuit has accessed said second electronic circuit in said special mode, said first electronic circuit sending a read command to said second electronic circuit to read information from said second electronic circuit.
